(19) United States
(12) Patent Application Publication
(10) Pub. No.: US 2005/0006914 A1
(43) Pub. Date: Jan. 13, 2005

(54) Disposable animal waste cleaning device and method of making

(76) Inventor: Douglas Milo Turner, Findley, OH (US)

Correspondence Address: KLEIN, O'NEILL & SINGH, 2 PARK PLAZA, SUITE 510, IRVINE, CA, 92614, US

(21) Appl. No.: 10/614,647

(22) Filed: Jul. 7, 2003

(51) Int. Cl. A01K 29/00; E01H 1/12

(52) U.S. Cl. 294/1.3

(57) ABSTRACT

An improved disposable combination animal waste pickup device and bag for sanitary pickup and disposal of animal waste has a first pickup portion formed from a cut-out blank, folded and sealed to a second holding portion, such as a bag, whereby animal waste may be picked up by the first pickup portion and sealingly held in the bag. The first pickup portion also includes a handle that is grasped by a user to cause the first pickup portion and bag to fold into each other so as to prevent leakage or loss of any waste in the bag.

### BACKGROUND OF THE INVENTION

1. Field of the Invention

This invention relates generally to waste pickup devices, and, more particularly, to an improved disposable, combination animal waste pickup scoop and bag for picking up and disposing of animal waste in a sanitary and efficient manner, and an improved method of making the same.

2. Description of Related Art

Animal owners and others are constantly faced with the need to pickup and dispose of litter or waste left by animals in unwanted areas, for example dog and/or cat litter deposited in yards, on sidewalks, on lawns, and the like. These persons use bags, gloves, shovels, scoops, towels and the like to pickup and dispose of animal waste. The animal waste picked up by such persons is usually placed in a disposable bag carried by or obtained by the person and thrown away, or if picked up by a scoop or shovel is emptied directly into any convenient trash barrel or waste container. This process tends to be messy and/or unsanitary, and many attempts have been made to make the process more convenient, easier, faster and more sanitary.

There are number of available devices for scooping up and disposing of pet litter. The known scoops are usually reusable and must be carried by the pet owner, with the scooped up litter placed in a separate bag or container made from plastic or other available materials for disposal. However, the available devices tend to be awkward or hard to use, or are complex and too expensive for everyday use.

Therefore, there exists the need in the art for an easy to use and manufacture disposable, combination scoop and bag for easily and quickly picking up and disposing of animal waste, and an improved method of assembling such a device.

### SUMMARY OF THE INVENTION

It is, therefore, a general object of the present invention to provide an improved and simplified animal waste cleanup device. It is a particular object of the present invention to provide an improved disposable animal waste cleanup device comprising a combination scoop and bag. It is another particular object of the present invention to provide an improved disposable animal waste cleanup device having an easily operated resilient chute with a biodegradable bag sealingly held thereto. It is a further particular object of the present invention to provide an improved disposable animal waste cleanup device into which animal waste may be easily inserted and sealed for disposal. It is yet another particular object of the present invention to provide an animal waste cleanup device having a handle for carrying the device after securing animal waste in a bag held to a chute. And, it is another particular object of the present invention to provide an improved method to form a disposable combination animal waste scoop and pickup device having a first portion formed as a resilient chute with a handle thereon and a bag for holding animal waste secured to the chute.

These and other objects and advantages of the present invention are achieved by providing a disposable combination animal waste pickup device and bag for sanitary pickup and disposal of animal waste in a facile manner. The device includes a first pickup portion formed from a cut-out blank, folded and sealed to a second holding portion, such as a bag, whereby animal waste may be picked up and sealingly held in the bag, and a handle grasped to cause the pickup portion and bag to fold into each other so as to prevent leakage or loss of any waste in the bag.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein like reference numerals are used throughout the several views, and, in which:

FIG. 1 is a top perspective view, with a portion broken away, of an improved combination animal waste pickup device and bag of the present invention, in the open or pickup position;

FIG. 2 is a rear elevational view of the device of FIG. 1;

FIG. 3 is a cross-sectional view taken along line 3-3 of FIG. 2;

FIG. 4 is an elevational view of a blank or form and a partial elevational view of a bag, showing how the blank is folded and sealed to the bag to form the improved combination animal waste pickup device and bag of the present invention; and

FIG. 5 is a perspective view of the improved combination animal waste pickup device and bag of the present invention, in the transport position, with a carrying handle at the top and a pickup portion and bag folded into each other.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide for an improved and simplified disposable combination animal waste pickup device and bag for picking up and disposing of animal waste, generally indicated at 10, throughout the several views.

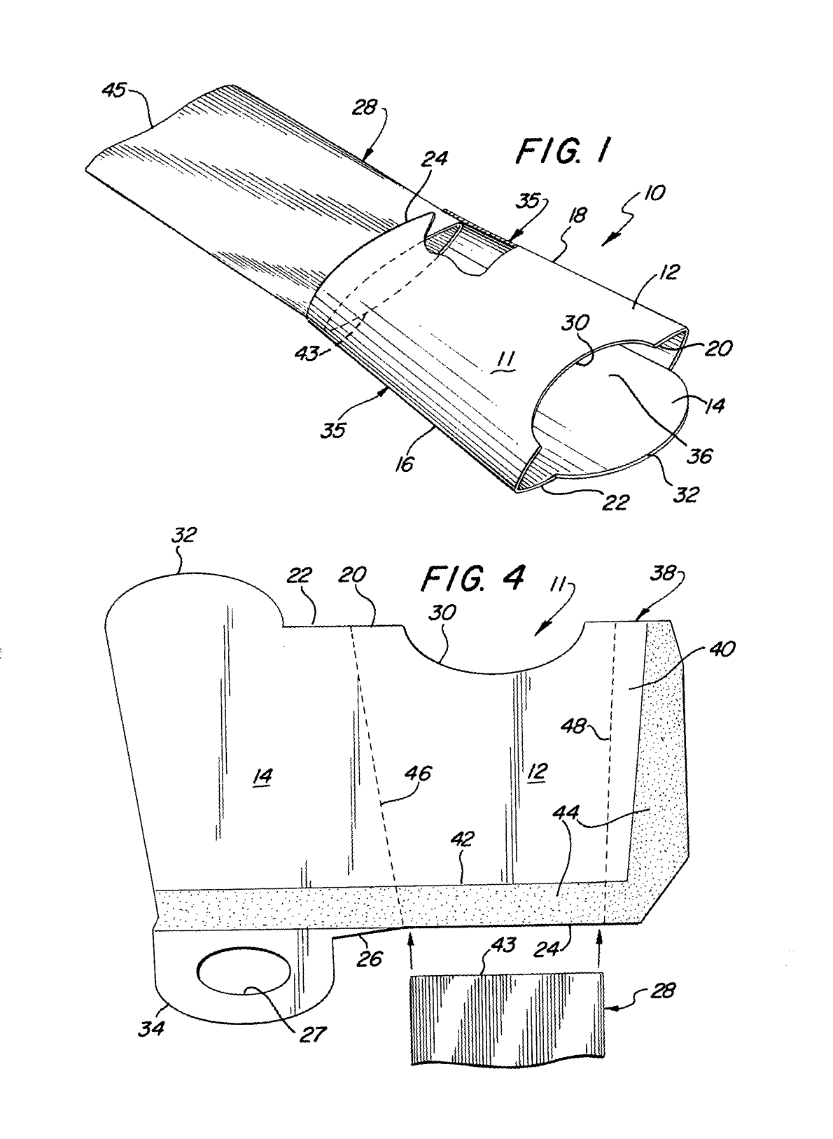

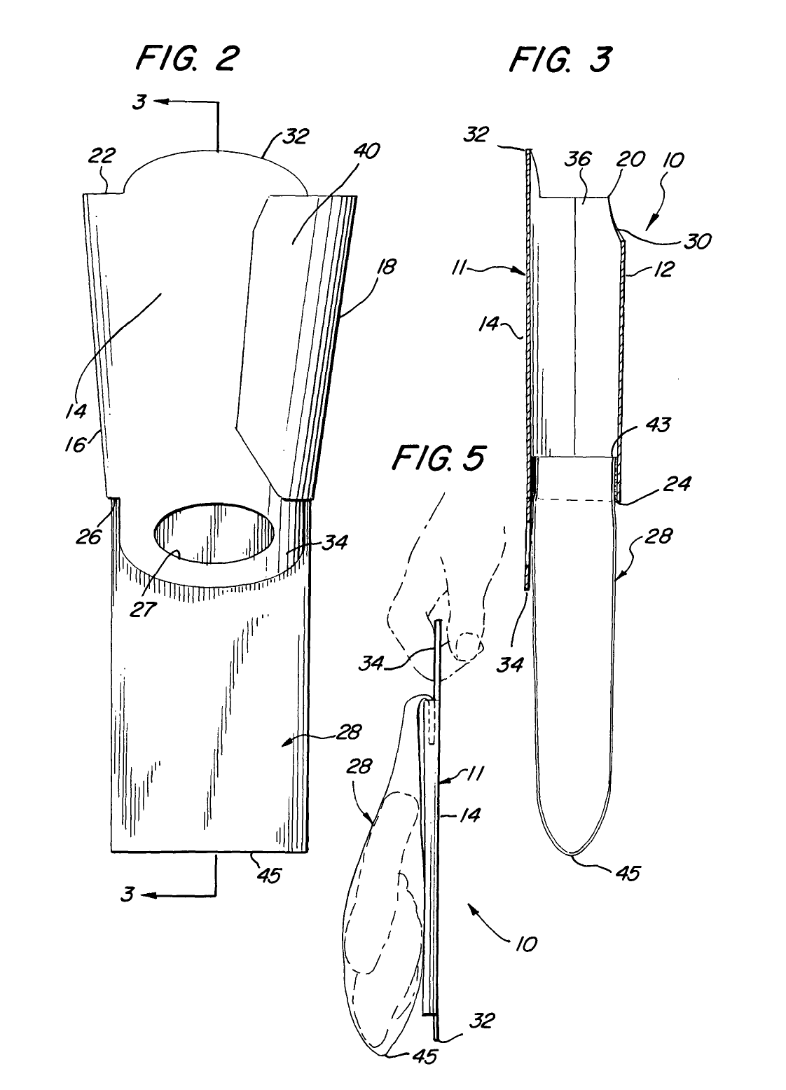

Turning now to the drawings, FIG. 1 show a preferred embodiment of the combination animal waste pickup device and bag 10 having a first or upper element 11, formed from a resilient material, such as cardboard or plastic, to provide a pickup portion or scoop. The first element or scoop 11 is comprised of a front portion 12 and a rear portion 14, of any desired size, with side edges 16, 18. The front portion 12 has an inner surface and an outer surface, a top end 20 with a radiused concave area 30 formed therein and a bottom end 24. The rear portion 14 has an inner surface and an outer surface, a top end 22 with a convexly shaped or rounded outer or scoop end 32 and a bottom end 26 having an extending portion with an opening 27 to form a handle 34 (see FIGS. 4 and 5). A bag 28 of any desired length, for example, from approximately 1″ to 24″ has an open top end 42 and a closed end 45. The bag 28 is preferably made from a biodegradable material, such as a 0.5 mil plastic or the like, and has its open end 42 secured to the bottom ends 24, 26 of the front and rear portions 12, 14, as described more fully below.

The front and rear portions 12, 14 are preferably formed so that the top ends 20, 22 are wider than the bottom ends 24, 26 to act as a chute or funnel, as described more fully below. The front and rear portions 12, 14 are resiliently secured together at the opposed side edges 16, 18 in such a manner that the opposed side edges act as hinges when squeezed by the hand of a user in the direction of arrows 35 to thereby flex or push the opposed inner surfaces of the front and rear portions away from a closed position contacting each other to an open position. That is, when the side edges 16, 18 are pushed inwardly, in the direction of the arrows 35 shown in FIG. 1, a chute, funnel or opening 36 is formed between the inner surfaces of the front and rear portions 12, 14 and side edges. Therefore, any animal waste picked up by the rounded or scoop end 32 of rear portion 14 will drop down the chute, funnel or opening 36 into the interior of the bag 28. The chute, funnel or opening 36 is preferably shaped so that any animal waste picked up by the scoop 32 is directed into the interior of the bag 28 by gravity, when the device 10 is moved to a vertical position.

After a person has picked up all the animal waste they wish to, or have filled the bag 28 through the chute, funnel or opening 32, the person releases their grip on the side edges 16, 18 to allow the resilient front and rear portions 12, 14 to move together or to the closed position with the inner surfaces together and the top end 43 of the bag 28 closed. As shown in FIG. 5, the person then grasps the handle 34 to cam or fold the device 10 inwardly, i.e., allow the bag 28 to move in a direction opposite to and away from the handle to both prevent the contents of the device 10 from escaping from the retaining bag 28 and to cover the scoop 32 so as to avoid any soiling of clothing or like by the scoop.

Referring now to FIG. 4, a preferred method of forming the device 10 of the present invention will now be described. A blank 38 is die-cut, stamped-out or otherwise formed to have the specific shape shown in FIG. 4. This die-cut blank 38 includes a first section comprising the rear portion 14 having the rounded outer end 32 at the top end 22 and the handle 34 with opening 27 formed at the lower end 26. The die-cut blank 38 also includes a second or central section comprising the front portion 12 having the radiused concave area 30 at the top end 20 and the lower end 24. Finally, the die-cut blank 38 includes a third section 40 that functions as a flap that wraps around to contact the rear portion 14 and hold the front and rear portions 12, 14 together, as explained more fully below.

The improved disposable combination scoop and bag 10 of the present invention is formed from the blank 38 and bag 28 by placing the bag on the bottom end of the front portion 12, on either the inner or surface, but preferably the inner surface, with the top open end 43 of the bag aligned with a line 42 on the inner surface. A hot melt glue or other sealing or securing means 44 is applied to selected portions of the blank 38 between line 42 and bottom edges 24, 26 and along section 40. The front and rear portions 12, 14 and section 40 are then folded together along fold lines 46, 48 to form the first element 11 and secure the bag 28 to the first element. The rear portion 14 is folded along fold line 46 over the front portion 12 until the inner surfaces are brought together. The third section of flap 40 is then folded along fold line 48 toward the rear portion 14, to more securely hold the front and rear portions together and to complete the formation of the side edges 16, 18 along the fold lines 46, 48. When folded together as described above, the glued together or sealed portions permanently seal the front and rear portions 12, 14 and the bag 28 together.

In use, the device 10 is operated by a user placing the device in one hand and pressing or squeezing the opposed side edges 16, 18 together, or toward each other, in the direction of arrows 35, to flex or move the closed front and rear portions apart and open the chute, funnel or opening 36. The convexly shaped outer end or scoop 32 at the top end 22 of the rear portion 14 is then manipulated to pickup litter from the ground and the device moved to a vertical position to allow the litter to fall into the interior of bag 28, without having to use any other item to move or push the litter. As explained above, after picking up the litter the user takes hold of the handle 34 to cam or fold the device 10, i.e., hinge the bag 28 and element 11 with respect to each other for ease in transporting the device and to both prevent the contents of the device 10 from escaping from the retaining bag 28 and to cover the scoop end 32, for sanitary purposes.

It, therefore, can be seen that the improved disposable combination scoop and bag of the present invention is easily formed from a die-cut or stamped-out blank of material having a number of different sized sections separated by fold lines. The device is formed by placing a bag in a central portion and bending or folding side sections over the central section around the fold lines, so as to secure the bag and folded element together with interior surfaces or faces of front and rear portions held together to form a normally closed resilient first element connected to the attached bag. The resilient first element is opened by squeezing side edges to form a chute, funnel or opening whereby litter may be picked up with a rounded outer end or scoop of a rear portion so that the litter passes through the open chute and into the interior of the attached bag. The side edges are then released to allow the chute to automatically close and seal the waste in the bag, and a handle grasped to move the first element and bag into a carrying position.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

1. A disposable device for picking up animal waste, comprising:
a first element having a front portion with a lower end and a upper end, a rear portion with a lower end and an upper end, and a pair of resilient sealed opposed side edges;
a resilient biodegradable bag sealed to the lower end of the front portion and the lower end of the rear portion;
the first element being formed from three separate portions that are folded along fold lines and sealed together with the resilient biodegradable bag;
a chute being formed in the first element between inner surfaces of the front portion and the rear portion and the pair of resilient sealed opposed side edges; and
the chute normally being in the closed position and being open to the interior of the bag when the pair of resilient sealed opposed side edges are pressed toward each other by a user.

2. The disposable device of claim 1, further including a handle secured to the lower end of the rear portion.

3. The disposable device of claim 2, further including a rounded portion on the outer end of the rear portion.

4. The disposable device of claim 3, further including a concave area formed on the outer end of the front portion.

5. The disposable device of claim 4, further including a flap secured to an outer surface of the rear portion to form one of the pair of resilient sealed opposed side edges and to aid in holding the facing surfaces of the front portion and the rear portion together.

6. The disposable device of claim 1 wherein the first element is formed from a die-cut blank having three separate sections that are folded along fold lines and sealed together by a glue applied to selected portions of the die-cut blank and the resilient biodegradable bag.

7. A method of forming a disposable device for picking up animal waste, comprising the steps of:
forming a blank having a front portion, a rear portion and a flap portion divided by a pair of fold lines;
forming the front portion with a rounded top end and a handle with an opening at a lower end;
forming in the rear portion with an open concave area in an upper end;
applying strips of glue to inner surfaces above the handle on the rear portion, along a lower end of the front portion and along a lower end and a side edge of the flap portion;
placing an open end of a bag against one of the strips of glue on the lower end of the front portion;
folding the rear portion toward the front portion along one of the pair of fold lines until inner surfaces meet each other, the bag and aligned strips of glue; and
folding the flap portion over until it contacts an outer face of the rear portion so as to form a combination chute and scoop with the bag secured thereto.

8. The method of claim 7, comprising the further steps of pressing flexible side edges of the combination chute and scoop to form an opening therein.

9. A blank for forming a combination chute and scoop for a disposable device for picking up animal waste, comprising:
a first section connected to second section and a third section by a pair of fold lines;
the first section having an inner surface, an outer surface, a rounded top end and a bottom end with a handle formed thereon;
the second section having an inner surface, an outer surface, a top end with a concave open area and a bottom end;
the third section comprising a flap having an inner surface, an outer surface; and
an adhesive applied to the bottom end of the inner surface of the first section at the bottom end, away form the handle, the bottom end of the inner surface of the second section and the inner surface of the flap, whereby when the first section is folded over the second section and the third section is folded over the first section the combination chute and scoop will be formed.

10. The blank of claim 9, further including a resilient bag inserted and held between the inner surface of the first section and the inner surface of the second section when they are folded and secured together.

11. The blank of claim 9 wherein the handle includes an opening formed therein.

12. The blank of claim 11, further including a resilient bag inserted and held between the inner surface of the first section and the inner surface of the second section when they are folded and secured together.

13. The blank of claim 9 wherein the rounded top end of the first section extends outwardly from the first section and acts as scoop.

14. The blank of claim 13, further including a resilient bag inserted and held between the inner surface of the first section and the inner surface of the second section when they are folded and secured together.

15. The blank of claim 9 wherein the concave open area formed on the outer end of the second section aids in directing animal waste into the combination chute and scoop.

16. The blank of claim 15, further including a resilient bag inserted and held between the inner surface of the first section and the inner surface of the second section when they are folded and secured together.
